(19) United States
(12) Patent Application Publication
(10) Pub. No.: US 2024/0256835 A1
(43) Pub. Date: Aug. 1, 2024

(54) TRAINING ULTRA-LARGE-SCALE VISION TRANSFORMER NEURAL NETWORKS

(71) Applicant: Google LLC, Mountain View, CA (US)

(72) Inventors: Mostafa Dehghani, Amsterdam (NL); Josip Djolonga, Zürich (CH); Jonathan Heek, Hilversum (NL); Basil Mustafa, Zürich (CH); Piotr Michal Padlewski, Zürich (CH); Justin Morgan Gilmer, Mountain View, CA (US); Neil Matthew Tinmouth Houlsby, Zürich (CH)

(21) Appl. No.: 18/424,420

(22) Filed: Jan. 26, 2024

Related U.S. Application Data
(60) Provisional application No. 63/441,419, filed on Jan. 26, 2023.

(51) Int. Cl. G06N 3/0455; G06N 3/088

(52) U.S. Cl. CPC G06N 3/0455; G06N 3/088

(57) ABSTRACT

Methods, systems, and apparatus, including computer programs encoded on computer storage media, for processing an input through each of a plurality of layers of a neural network to generate an output using a plurality of hardware accelerators. The plurality of layers comprise a fully connected layer having a plurality of parameters arranged in a row dimension and a column dimension. One of the methods comprises: generating a plurality of parameter blocks by partitioning the plurality of parameters along the row dimension and the column dimension; determining a ratio of a number of parameters along the row dimension relative to a number of parameters along the column dimension; and determining whether to use row sharding or column sharding with the plurality of hardware accelerators to calculate an output for the fully connected layer and then calculating the output for the fully connected layer using either row sharding or column sharding.

### CROSS-REFERENCE TO RELATED APPLICATION

This application claims priority to U.S. Provisional Application No. 63/441,419, filed on Jan. 26, 2023. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that implements a Vision Transformer (ViT) neural network. A ViT is a neural network that includes one or more attention blocks and that processes an input that includes an image or data derived from the image to generate an output for the input, e.g., a classification or a regression output for the image.

The subject matter described in this specification can be implemented in particular embodiments so as to realize one or more of the following advantages. This specification describes techniques that enable scalability to tens of billions of parameters in an ultra-large ViT neural network, where in general, the more the model parameters, the better the performance of the ViT neural network on any of a range of image recognition tasks, including object detection, image classification, semantic segmentation, action recognition, to name just a few examples. In some cases, the ultra-large ViT neural network can be pre-trained on a large unlabeled training dataset, and then subsequently adapted, e.g., through one-shot or few-shot learning, to any of these tasks. Once adapted, the ultra-large ViT neural network can exceed the performance of a conventional ViT neural network that has a smaller model size on any of these tasks.

Some techniques described in this specification can modify the architecture of the VIT neural network to (i) have parallel attention layers and MLP blocks that operate on the same input sequence, (ii) apply layer normalizations in computing the query Q and key K projections for the attention mechanism, and (iii) omit biases in the QKV projections, to improve both the training stability and the efficiency of the ViT neural network. Therefore it becomes possible to scale the ViT neural network up to an arbitrarily large level while preventing diverging losses from hindering successful training, and without causing an excessively large increase in computation resource consumption during the training.

Some techniques described in this specification can implement a machine learning training framework suitable for training a large-scale neural network, e.g., the aforementioned ultra-large ViT neural network or another giant neural network, by using model parallelism to ensure training efficiency. By having the computation of matrix multiplications at each hardware device and the communication of matrices between hardware devices to overlap with each other at each hardware cycle, the framework improves hardware utilization of each individual hardware device and improves device efficiency, all while minimizing communication latency between the hardware devices. The above modifications of the architecture of the VIT, for example, the parallel attention layers and MLP blocks operating on the same input sequence and the omission of biases in the QKV projections, enables easier implementation of model parallelism and facilitates more efficient implementation on distributed/parallel processing systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a diagram of an example illustration of a ViT neural network.

FIG. 3 is a flow diagram of an example process for processing an input through each of a plurality of layers of a neural network to generate an output using a plurality of hardware accelerators.

FIG. 4 is a flow diagram of an example process for using row sharding with a plurality of hardware accelerators.

FIG. 5 is an example illustration of using row sharding with a plurality of hardware accelerators.

FIG. 6 is a flow diagram of an example process for using column sharding with a plurality of hardware accelerators.

FIG. 7 is an example illustration of using column sharding with a plurality of hardware accelerators.

FIG. 8 is a flow diagram of an example process for performing a machine learning task on a network input to generate a network output.

Like reference numbers and designations in the various drawings indicate like elements.

### DETAILED DESCRIPTION

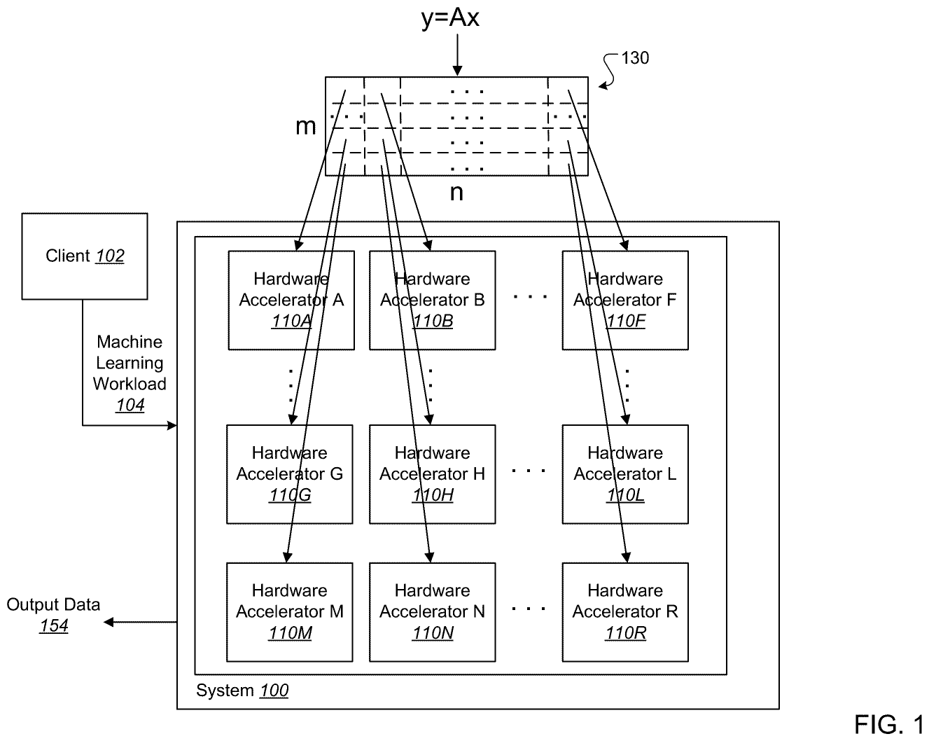

FIG. 1 illustrates an example system 100 for executing a machine learning workload 104. The machine learning workload 104 can be specified by a client 102. The system 100 can receive data specifying the machine learning workload 104 from the client 102, and generate output data 154 as a result of the execution of the machine learning workload 104.

The machine learning workload include computations for training a neural network or computing an inference using a neural network to generate an output for a machine learning task.

In some cases, the neural network is a large-scale neural network. A large-scale neural network is a neural network with many network parameters, e.g., 1 billion parameters, 10 billion parameters, 100 billion parameters, or 500 billion or more parameters.

In some cases, the neural network is a language model neural network that has any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv:2005.14165, 2020.

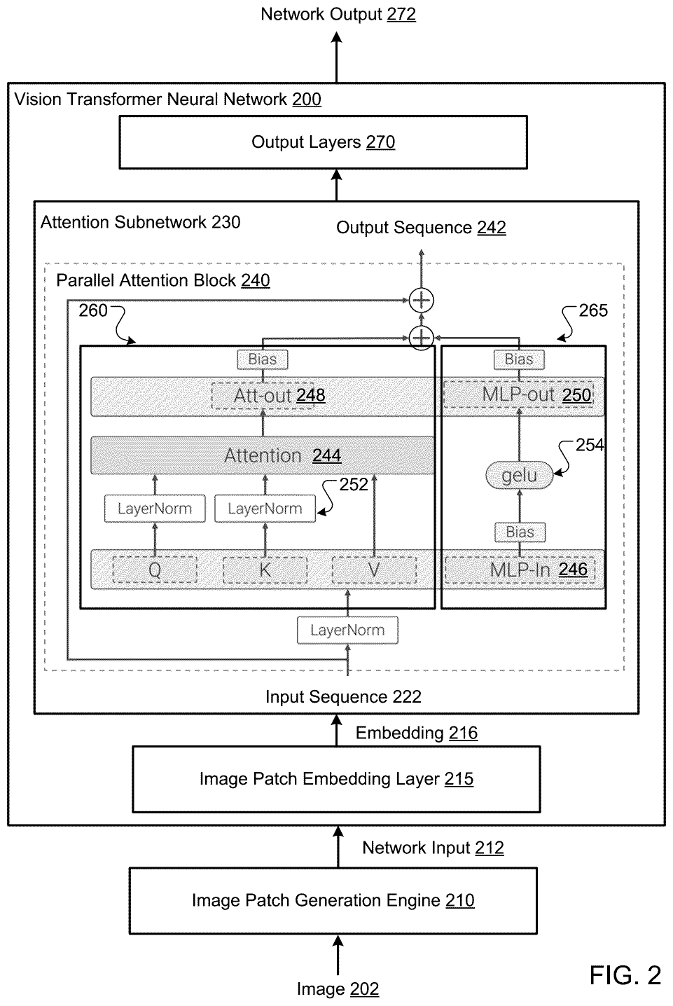

In some cases, the neural network is a visual model neural network that has any of a variety of Vision Transformer (ViT) neural network architectures. Examples of such architectures include those described in Xiaohua Zhai, Alexander Kolesnikov, Neil Houlsby, and Lucas Beyer. Scaling vision transformers. In CVPR, pages 12104-12113, 2022; and Xi Chen, et al. PaLI: A jointly-scaled multilingual language-image model. arXiv preprint arXiv:2209.06794, 2022. A particular ViT architecture is described in more detail below with reference to FIG. 2.

In any of these cases, the neural network can be configured to receive any kind of digital data input and to perform any kind of machine learning task (e.g., generative task, classification task, or regression task) on the input to generate an output. A few examples follow.

In some cases, the neural network is a neural network that is configured to perform an image processing task, i.e., receive an input image and to process the input image to generate a network output for the input image. An input image may comprise a plurality of pixel values. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the neural network can be configured to perform multiple individual natural language understanding tasks, with the input including an identifier for the individual natural language understanding task to be performed on the network input.

In some cases, the task is a multi-modal task that requires processing both text and image inputs, so that the neural network includes both a computer vision neural network, e.g., that has a ViT neural network architecture, and a text processing neural network, e.g., that has a Transformer-based neural network architecture. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In the cases where the system 100 executes the machine learning workload 104 for training a neural network, the system 100 can receive architecture data defining an architecture of the neural network. The architecture defines the number of layers in the neural network, the operations performed by each of the layers, and the connectivity between the layers in the neural network, i.e., which layers receive inputs from which other layers in the neural network.

The system 100 can also receive training data for training the neural network to perform one or more of the machine learning tasks mentioned above. Generally, the training data includes a set of neural network inputs and, optionally, for each network input, a respective target output that should be generated by the neural network to perform the particular task. In some cases, a larger set of training data may be randomly partitioned by the system to generate the training data and a validation set for evaluating the performance of the neural network on the tasks.

While FIG. 1 illustrates one client 102, the system 100 can execute the computation on behalf of many clients. In other words, the system 100 can receive respective data specifying different machine learning workloads from two or more clients, execute the different workloads with at least some degree of concurrency, and generate respective output data as a result of the execution of the different machine learning workloads. Each client can be physically adjacent to the system 100, e.g., located within a same data center as (some parts of) the system 100, or can alternatively be a cloud client that is remote from the system 100. In the latter case, the system 100 can be at least partially controlled by the cloud client. Each client can run, for example, on a desktop computer, a laptop computer, a tablet computer, a wearable computer, a cellular phone, a smart phone, a music player, an e-book reader, a navigation system, or any other appropriate computing device. Each client can communicate with the system 100 over a data communication network.

The system 100 can receive the architecture data and training data in any of a variety of ways. For example, the system 100 can receive the architecture data as an upload from the client 102 over the data communication network, e.g., using an application programming interface (API) made available by the system 100. As another example, the system 100 can receive an input from the client 102 specifying which data that is already maintained by the system 100, or another cloud storage system that is accessible by the system, should be used for training the neural network.

Once the system 100 trains the neural network through the execution of machine learning workload 104, the system can provide data specifying the trained neural network for use in processing new network inputs. That is, the system can output the trained values of the network parameters to the client 102 for later use in processing inputs using the trained neural network, e.g., by outputting to a user device or by storing in a memory accessible to the system.

Alternatively or in addition to outputting the trained neural network data, the system 100 can instantiate an instance of the neural network having the trained values of the network parameters, and receive inputs to be processed and use the trained neural network to process the received inputs to generate outputs and then provide the generated outputs in respect to the received inputs. The system can receive network inputs through an application programming interface (“API”) offered by the system. The trained neural network can be used to process any of a variety of machine learning tasks described above.

The system 100 is typically hosted within a data center, which can be a distributed, cloud-based computing system having a plurality of hardware accelerators, i.e., hardware accelerators A 110A—hardware accelerator R 110R, e.g., a group of hundreds or thousands of hardware accelerators, in one or more locations. The hardware accelerators are interconnected with one another over an accelerator interconnect network. For example, the accelerator interconnect network can be an Inter-Core Interconnect (ICI) network.

Hardware accelerators (or “accelerators” for short) are computing devices having specialized hardware configured to perform specialized computations including, e.g., machine learning computations. Examples of accelerators include graphics processing units (“GPUs”), field-programmable gate arrays (“FGPAs”), and application-specific integrated circuits (“ASICs”), including tensor processing units (“TPUs”).

The plurality of hardware accelerators enable the system 100 to use various forms of parallelism including, e.g., task parallelism, data parallelism, and pipeline parallelism, and, in particular, model parallelism, when executing the machine learning workload 104 to achieve high efficiency, e.g., to reduce the amount of time, computing resources, and power resources needed to train the neural network to the level of accuracy required. When the neural network is a large-scale neural network that has hundreds of billions of parameters, the savings in time, computing resources, and power resources can be significant.

When model parallelism is used in executing the machine learning workload 104, each hardware accelerator stores a respective portion of the architecture (a respective “submodel”) of the neural network, e.g., a respective portion of a layer of the neural network, or a respective portion of two or more layers of the neural network.

Under model parallelism, each hardware accelerator takes model activation input from its local data, or from the output of another hardware accelerator that operates on hidden layers before itself, or from both its local data and the output of another hardware accelerator. The hardware accelerator then computes the activation output, which can either be a final network output, or serve as the activation input of another hardware accelerator, based on the submodel that is stored on the hardware accelerator and on the model activation input. When the machine learning workload 104 includes computations for training the neural network, the gradient is computed on the hardware accelerator that includes the final layer, and gets sent back to the previous layers to update the submodels. This process can be pipelined to operate on successive mini-batches of network inputs.

In the example of FIG. 1, the neural network includes a fully connected layer that has a plurality of parameters. The plurality of parameters for the fully connected layer can be arranged in a parameter matrix 130 A ∈ [symbol] where m represents the row dimension, and n represents the column dimension. The plurality of parameters for the fully connected layer can include the weights of the fully connected layer.

Executing the machine learning workload 104 in FIG. 1 thus involves computing, by the system 100, a product between a parameter matrix 130 representing the weights of the layer and a matrix (or vector) x representing the layer input to generate the product y=Ax that represents the layer output of the fully connected layer. In particular, in this example, the fully connected layer has no bias, and thus the system 100 adds no bias to the product to generate the layer output. In other examples where the fully connected layer has biases, the system 100 also adds the bias to the product to generate the layer output.

To use model parallelism in this example, FIG. 1 thus illustrates that the system 100 partitions the parameter matrix 130 into a plurality of parameter blocks along the row dimension and the column dimension of the parameter matrix 130, where each parameter block includes a subset of the plurality of parameters for the fully connected layer, and then stores a respective parameter block at each hardware accelerator.

For example, hardware accelerator A 110A stores a parameter block that includes a first subset of the plurality of parameters for the fully connected layer, hardware accelerator B 110B stores a parameter block that includes a second subset of the plurality of parameters for the fully connected layer, and so on. Note that this mapping from parameter blocks to hardware accelerators is for illustrative purposes only; in general each hardware accelerator will store different parameter blocks over the course of the execution of the machine learning workload 104.

There are two ways to achieve model parallelism: row sharding and column sharding. Row sharding differs from column sharding in how the plurality of parameter blocks (that each includes a respective subset of the plurality of parameters for the fully connected layer) are loaded into each hardware accelerator.

In row sharding, the parameter matrix 130 is row-sharded across the hardware accelerators. That is, for a given hardware accelerator, the parameter blocks arranged along a corresponding row dimension are loaded one after another into the given hardware accelerator over multiple hardware cycles. Alternatively, in column sharding, the parameter matrix 130 is column-sharded across the hardware accelerators. That is, for a given hardware accelerator, the parameter blocks arranged along a corresponding column dimension are loaded one after another into the given hardware accelerator over multiple hardware cycles.

As will be described in more detail below, for any given fully connected layer included in the neural network, the system 100 determines whether to use row sharding or column sharding to achieve model parallelism based on the row and column dimensions of the parameter matrix 130 for the given fully connected layer, i.e., based on how n compares to m.

By dynamically choosing between row sharding or column sharding to achieve model parallelism when executing the machine learning workload 104 based on the dimensions of the parameter matrices for different fully connected layers included in the neural network, the system 100 can improve hardware utilization of the hardware accelerators and, in the meanwhile, reduce the network overhead by minimizing the communication of intermediate data (e.g., the model activation inputs and outputs) across the hardware accelerators.

FIG. 2 is a diagram of an example illustration of a Vision Transformer (ViT) neural network 200. The ViT neural network 200 can be implemented on a system of one or more computers in one or more locations. For example, the ViT neural network 200 can correspond to the neural network that is involved in the machine learning workload executed by the system 100 of FIG. 1.

The ViT neural network 200 obtains a network input 212 that includes a plurality of image patches of an image 202. Each image patch includes a different subset of the pixels of the image 202.

The image 202 can be any appropriate type of image. For example, the image 202 can be a two-dimensional image, e.g., a two-dimensional image that has multiple channels (e.g., an RGB image). As another example, the image 202 can be a hyperspectral image that represents a continuous spectrum of wavelengths, e.g., by identifying, for each pixel in the image 202, a distribution over the spectrum. As another example, the image 202 can be a point cloud that includes multiple points, where each point has a respective coordinate, e.g., in a three-dimensional or a higher-dimensional coordinate space; as a particular example, the image 202 can be a point cloud generated by a LIDAR sensor. As another example, the image 202 can be a medical image generating by a medical imaging device; as particular examples, the image 202 can be a computer tomography (CT) image, a magnetic resonance imaging (MRI) image, an ultrasound image, an X-ray image, a mammogram image, a fluoroscopy image, or a positron-emission tomography (PET) image.

In FIG. 2, an image patch generation engine 210 is configured to process the image 202 and to generate the image patches of the image 202. The image patch generation engine 210 may, but need not, be included as a part of the ViT neural network 200. In this specification, an image patch of an image is a strict subset of the pixels of the image.

Each image patch can be represented in any appropriate way, e.g., as a two-dimensional image or as a one-dimensional sequence of the pixels of the image patch. Generally, each image patch includes multiple contiguous pixels of the image 202. In some cases, each pixel in the image 202 is included in exactly one of the image patches. For example, the image patch generation engine 210 can partition the image 202 into equal sized patches to generate the image patches.

The ViT neural network 200 includes an image patch embedding layer 215. The image patch embedding layer 215 is configured to obtain the plurality of image patches of the image 202, and to generate a corresponding embedding 216 of each of the plurality of image patches. These embeddings are also referred to as image patch embeddings.

Each image patch embedding 216 represents the pixels of the corresponding image patch and can be generated by processing the pixels of the corresponding image patch. Each image patch embedding 216 can be generated in any appropriate way, e.g., by processing the image patch using a linear projection, e.g., a learned linear projection. As a particular example, each image patch embeddings 216 can be generated by using the embedding techniques described in Alexey Dosovitskiy, et al. An image is worth 16×16 words: Transformers for image recognition at scale. In ICLR, 2021.

In this specification, an embedding is an ordered collection of numeric values that represents an input in a particular embedding space. For example, an embedding can be a vector of floating point or other numeric values that has a fixed dimensionality.

The ViT neural network 200 includes an attention subnetwork 230. The ViT neural network 200 receives the corresponding embedding 216 of each of the plurality of image patches as input, and processes the input to generate an output.

In particular, the attention subnetwork 230 includes a stack of one or more parallel attention blocks 240. Each parallel attention block 240 receives an input sequence 222 and processes the input sequence 222 to generate an output sequence 242. The input sequence 222 includes a respective input element at each of a plurality of positions, where the input sequence 222 includes a respective input element corresponding to each of the plurality of image patches. In some implementations, the output sequence 242 has the same length as the input sequence 222, i.e., that includes a respective output element for each input element in the input sequence.

Generally, the attention subnetwork 230 generates the output sequence 242 by repeatedly updating the elements in the input sequence 222 by using the stack of one or more parallel attention blocks 240.

For the first parallel attention block 240 in the stack, the input sequence 222 can be the corresponding embedding 216 of each of the plurality of image patches that are generated by the image patch embedding layer 215. For any subsequent parallel attention block 240 in the stack, the input sequence 222 can be the output sequence 242 generated by the preceding parallel attention block 240 in the stack. The output sequence 242 generated by the last parallel attention block 240 in the stack can be used as the output of the attention subnetwork 230.

The ViT neural network 200 includes one or more output layers 270. The one or more output layers 270 receives one or more of the output elements included in the output of the attention subnetwork 230 as input, and processes the input to generate a network output 272 for the image 202.

In some implementations, the one or more output layers 270 include an embedding layer that maps one or more of the output elements included in the output of the attention subnetwork 230 to a final embedding, and a linear layer that maps the final embedding to the network output 272.

In some implementations, the one or more output layers 270 include an aggregation layer that combines the output elements included in the output of the attention subnetwork 230, e.g., using global average pooling (GAP) or multihead attention pooling (MAP), to generate an aggregated output element, followed by a linear layer that maps the aggregated output element to the network output 272.

In some implementations, the network output 272 is a classification output for the image 202. A classification output generally includes a respective score corresponding to each of multiple categories. The score for a category indicates a likelihood that the image belongs to the category. In some cases, the categories may be classes of objects (e.g., dog, cat, person, and the like), and the image may belong to a category if it depicts an object included in the object class corresponding to the category. The object categories may be generic, e.g., horses, or specific, e.g., George Washington. In some cases, the categories may represent global image properties (e.g., whether the image depicts a scene in the day or at night, or whether the image depicts a scene in the summer or the winter), and the image may belong to the category if it has the global property corresponding to the category. In other implementations, the network output 272 may comprise an image processing output according to any image processing task as described above.

Each parallel attention block 240 includes an attention block 260 and a multi-layer perceptron (MLP) 265. The attention block 260 includes an attention layer 244 and, in some implementations, an attention output projection layer 248.

The attention layer 244 receives the input sequence 222 for the block and applies an attention mechanism on the input sequence 222 for the block to generate an attended input sequence. The attention mechanism applied by the attention layer 244 can be, for example, a multi-head self-attention mechanism or another variant of a query-key-value (QKV) attention. Applying the attention mechanism generally involves computing attention weights based on a set of queries Q, keys K, and values V derived from the input sequence 222 by using a query Q linear projection layer, a key K linear projection layer, and a value V linear projection layer included in the attention layer.

In implementations where the attention block 260 also includes the attention output projection layer 248, the attention block 260 further processes the attended input sequence using the attention output projection layer 248 to generate a projected attended input sequence. In these implementations, the attended input sequence is thus the projected attended input sequence generated by the attention output projection layer 248. In the example of FIG. 2, the attention output projection layer 248 include both an attention output projection matrix and an attention output projection bias vector. Thus, to generate the projected attended input sequence, the input MLP 246 applies the attention output projection matrix to the attended input sequence and then adds the attention output projection bias vector.

The MLP 265 includes an input multi-layer perceptron (MLP) 246 that processes the input sequence 222 for the block using one or more feed-forward layers to generate a transformed input sequence. The transformed input sequence includes a respective transformed input element for each of the plurality of positions.

The MLP 265 also includes an activation layer 254 that follows the input MLP 246. The activation layer 254 applies a non-linear activation function to the transformed input sequence to generate an activated transformed input sequence. In the example of FIG. 2, the activation layer 254 is a Gaussian Error Linear Unit (GELU) that applies a GELU activation function. In other examples, however, the activation layer 254 can be a different type of non-linear elementwise activation layer, e.g., a ReLU activation layer that applies a ReLU activation function, or a sigmoid activation layer that applies a sigmoid activation function.

The MLP 265 further includes an output multi-layer perceptron (MLP) 250 that follows the activation layer 254 and that processes the activated transformed input sequence using one or more feed-forward layers to generate a further transformed input sequence. The further transformed input sequence includes a respective further transformed input element for each of the plurality of positions.

Each block is referred to as “parallel attention” block because within the block, the MLP 260 is arranged in parallel with the attention block 260 and is configured to operate on the input sequence 222 for the block to generate a further transformed input sequence, e.g., instead of being stacked atop the attention block 260 and configured to operate on the attended input sequence.

In particular, in this parallel configuration, the attention block 260 and the MLP 265 are configured to receive the same input sequence for the block. Each block then generates the output sequence 242 for the block based on (i) the attended input sequence and (ii) the further transformed input sequence.

In the example of FIG. 2, the attention subnetwork 230 further includes a layer normalization layer and a residual connection layer. The layer normalization layer applies layer normalization to the input sequence 222, i.e., before it is received by the attention layer 244. The residual connection layer combines (i) the input sequence 222 with (ii) the attended input sequence generated by the attention block 260 and (iii) the further transformed input sequence generated by the MLP 265, to generate the output sequence 242.

In the example of FIG. 2, the one or more feed-forward layers included in either the input MLP 246 or the output MLP 250 each include both a respective projection parameter matrix and a respective projection bias vector. On the other hand, the query Q linear projection layer, the key K linear projection layer, and the value V linear projection layer included in the attention layer 244 each have a respective projection matrix while having no bias vectors. That is, biases are omitted from the query Q, key K, and value V linear projection layers. Omitting the biases here can improve hardware accelerator utilization (for example, when implemented using the system 100 of FIG. 1) without task performance loss.

Thus, to generate the transformed input sequence, the input MLP 246 applies a projection parameter matrix to the input sequence and then adds a bias vector. Likewise, to generate the further transformed input sequence, the output MLP 250 applies another projection parameter matrix to the activated transformed input sequence and then adds another bias vector.

On the other hand, to generate the set of queries Q, the attention layer 244 applies a query parameter matrix to the input sequence 222, and adds no bias vector. Likewise, to generate the set of keys K, the attention layer 244 applies a key parameter matrix to the input sequence 222, and adds no bias vector; to generate the set of values V, the attention layer 244 applies a value parameter matrix to the input sequence 222, and adds no bias vector.

In the example of FIG. 2, the query Q linear projection layer has a layer normalization layer, and the key K linear projection layer has a layer normalization layer, but the value V linear projection layer has no layer normalization layer. Thus, after applying the query parameter matrix to the input sequence 222, the attention layer 244 then applies layer normalization to generate the set of queries Q. Likewise, after applying the key parameter matrix to the input sequence 222, the attention layer 244 then applies layer normalization to generate the set of keys K. When applied, the layer normalization might prevent training loss divergence by lowering large attention logit values. On the other hand, after applying the value parameter matrix to the input sequence 222, the attention layer 244 applies no layer normalization to generate the set of values V.

For example, applying the query (or key) parameter matrix to the input sequence and then applying the layer normalization to generate the set of queries Q (or keys K) can be defined as:

$$softmax [ \frac{1}{\sqrt{d}} LN ( {XW}^{Q} ) {( LN ( {XW}^{K} ) )}^{T} ] ,$$

where d is query/key dimension, X represents the input sequence, LN stands for layer normalization, and W^{Q} represents the query parameter matrix, and W^{K} represents the key parameter matrix.

The ViT neural network 200 is generally “scaled up” relative to conventional ViTs, i.e., has significantly more parameters than conventional ViTs. For example, the ViT neural network 200 can have 10 billion or more parameters, approximately 22 billion parameters, or more than 22 billion parameters.

To “scale up” a conventional ViT, increases can be made to one or more of: the number of parallel attention blocks (depth of the neural network), the dimensionality of the image patch embeddings and vectors operated on by the attention mechanisms (width of the neural network), the number of attention heads in the attention mechanism, and the hidden dimension of the MLP block within each of the parallel attention blocks (MLP-width). All of the above increases generally increase the total number of parameters with the parallel attention blocks of the ViT.

The architecture of the ViT neural network 200—and in particular, the parallel attention blocks, omitting biases from the query Q, key K, and value V linear projection layers, and the use of layer normalization with the query Q linear projection layer and the key K linear projection layer-makes it feasible to scale the ViT neural network up 200 to an arbitrarily large level while preventing diverging losses from hindering successful training, and without causing an excessively large increase in computation resource consumption during the training.

Table 1 shows an example of a scaled up ViT neural network that has approximately 22 billion parameters in comparison to conventional ViTs including ViT-G that has approximately 2 billion parameters (described in Xiaohua Zhai, et al. Scaling vision transformers. In CVPR, pages 12104-12113, 2022) and ViT-e that has approximately 4 billion parameters (described in Xi Chen, et al. PaLI: A jointly-scaled multilingual language-image model. arXiv preprint arXiv:2209.06794, 2022):

TABLE 1
ViT-22B model architecture details.

| Name | Width | Depth | MLP | Heads | Params [M] |
|---|---|---|---|---|---|
| ViT-G | 1664 | 48 | 8192 | 16 | 1843 |
| ViT-e | 1792 | 56 | 15360 | 16 | 3926 |
| ViT-22B | 6144 | 48 | 24576 | 48 | 21743 |

As a particular example, the ViT neural network 200 can be implemented on the system 100 of FIG. 1, which can train the ViT neural network 200 on training data using a framework that uses the model parallelism as mentioned above and possibly in combination with other forms of parallelism, including, e.g., task parallelism, data parallelism, and pipeline parallelism to ensure inference and training efficiency while accommodating the enormous number of model parameters of the ViT neural network 200.

The training data can include a plurality of training images and a respective target classification output for each training image. The framework implemented by the system 100 of FIG. 1 allows for overlapping communication and computation across multiple hardware accelerators performing parallel linear operations (e.g. any of the query Q, key K, value V linear projection layers and the input MLP 246 as parallel operations, and/or the attention output projection layer 248 and the output multi-layer perceptron 250 as parallel operations) in either a row sharding mode or a column sharding mode, which can be selected dynamically based on the dimensions of the parameter matrices. It will be appreciated that this also applies to inference in addition to training.

After this training, the system can train a downstream neural network that includes the parallel attention blocks 240 together with another set of output layers, on a different, downstream task, e.g., on a different classification task or on a regression task. For example, the downstream task can be a computer vision task, where the input is an image and the output is a computer vision output for the image, e.g., a depth estimation output that includes a respective depth estimation for each of a plurality of pixels. Each depth estimation represents information about the distance of a surface in an environment relative to a camera sensor that captures the image.

As a particular example, the downstream neural network can be configured to generate a classification output that includes a respective score corresponding to each of multiple categories, where the multiple categories are different from those used in the initial training.

As another particular example, the downstream neural network can be configured to generate a pixel-level classification output that includes, for each pixel in the image, a respective score corresponding to each of multiple categories. For a given pixel, the score for a category indicates a likelihood that pixel belongs to the category. In some cases, the categories may be classes of objects, and a pixel may belong to a category if it is part on an object included in the object class corresponding to the category. That is, the pixel-level classification output may be semantic segmentation output.

As another particular example, the downstream neural network can be configured to generate a regression output that estimates one or more continuous variables (i.e., that can assume infinitely many possible numerical values) that characterize the image. In a particular example, the regression output may estimate the coordinates of bounding boxes that enclose respective objects depicted in the image. The coordinates of a bounding box may be defined by (x, y) coordinates of the vertices of the bounding box.

In some implementations, the downstream neural network can be configured to perform a video analysis task. For example, the system can receive multiple images that are video frames of a video, and can process each video frame as described above to generate an output that characterizes the video frames, e.g., by characterizing whether the video frames depict a person performing a particular action.

In some cases, the parameters of the parallel attention blocks 240 are fine-tuned during the training on the training data for the downstream task. In other cases, the parameters of the parallel attention blocks 240 are held fixed and only the parameters of the different set of output layers for the downstream tasks are updated.

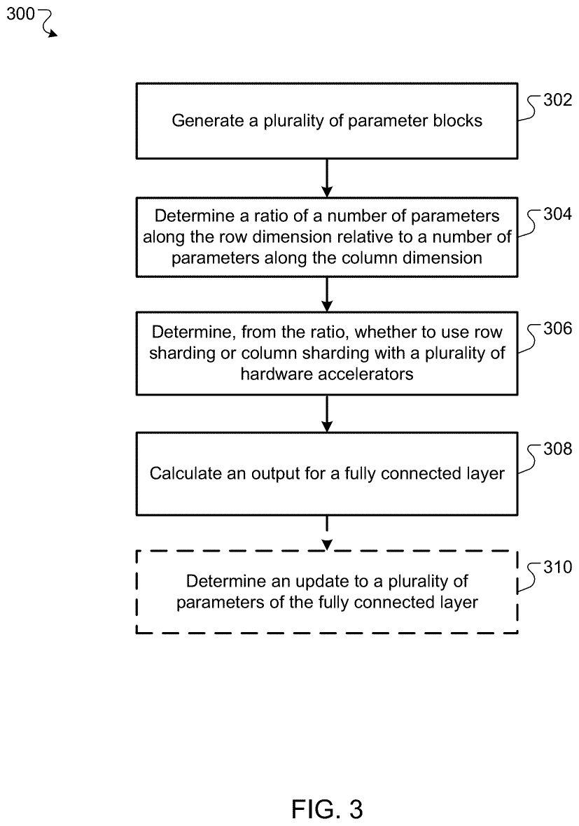

FIG. 3 is a flow diagram of an example process 300 for processing an input through each of a plurality of layers of a neural network to generate an output using a plurality of hardware accelerators. For convenience, the process 300 will be described as being performed by a system of one or more computers located in one or more locations. For example, a system, e.g., the system 100 of FIG. 1, appropriately programmed, can perform the process 300. In some cases, the neural network is a ViT neural network that operates on input sequences includes image patches of an image. For example, the neural network can correspond to the ViT neural network 200 of FIG. 2. In other cases, the neural network is a neural network that is not a ViT. For example, it can be a Transformer-based neural network that operates on input sequences that are not (or do not include) image patches, e.g., that operates on textual input sequences. In either cases, the plurality of layers can include a fully connected layer. The fully connected layer is associated with a parameter matrix that includes a plurality of parameters for the fully connected layer that are arranged in a row dimension and a column dimension.

$$A ∈ {ℝ}^{m \times n} k {A}_{i , j} ∈ {ℝ}^{\frac{m}{k} \times \frac{n}{k}} i , j ∈ \{ 1 , … , k \} n > mn = 4 m$$

The system generates a plurality of parameter blocks by partitioning the plurality of parameter along the row dimension and the column dimension according to a number of the plurality of hardware accelerators (step 302). Each parameter block includes a respective subset of the plurality of parameters for the fully connected layer. For example, assuming the fully connected layer has a parameter matrix, and that there are a total of hardware accelerators, each parameter block can be defined as:, where

$$A ∈ {ℝ}^{m \times n} k {A}_{i , j} ∈ {ℝ}^{\frac{m}{k} \times \frac{n}{k}} i , j ∈ \{ 1 , … , k \} n > mn = 4 m$$

The system determines a ratio of a number of parameter values along the row dimension relative to a number of parameter values along the column dimension (step 304). That is, the system determines how n compares to m.

$$A ∈ {ℝ}^{m \times n} k {A}_{i , j} ∈ {ℝ}^{\frac{m}{k} \times \frac{n}{k}} i , j ∈ \{ 1 , … , k \} n > mn = 4 m$$

The system determines, from the ratio, whether to use row sharding or column sharding with the plurality of hardware accelerators to calculate an output for the fully connected layer (step 306). Generally, the system chooses to use column sharding when the number of parameter values along the row dimension is greater than the number of parameter values along the column dimension, i.e., when the ratio is greater than one. Put another way, the system chooses to use column sharding when. In some implementations, the system chooses to use column sharding when, and row sharding elsewhere.

The system calculates the output for the fully connected layer using either row sharding or column sharding, in accordance with the determination made in step 306 (step 308).

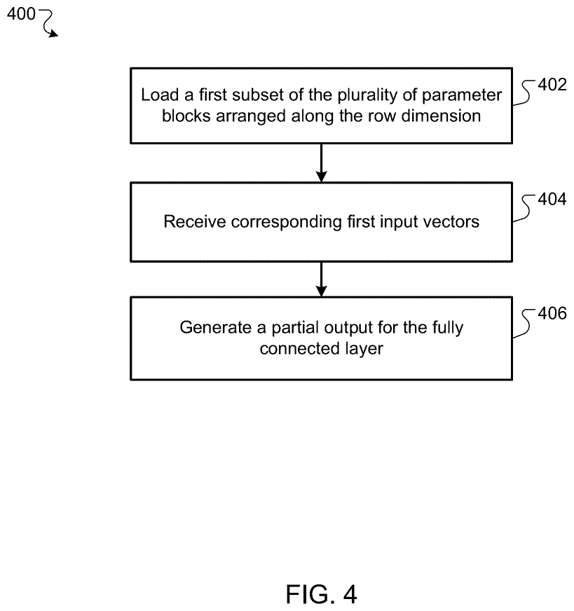

FIG. 4 is a flow diagram of an example process 400 for using row sharding with the plurality of hardware accelerators to calculate the output for the fully connected layer. For convenience, the process 400 will be described as being performed by a system of one or more computers located in one or more locations. For example, a system, e.g., the system 100 of FIG. 1, appropriately programmed, can perform the process 400.

Process 400 can be performed at each of the plurality of hardware accelerators (referred to below as “a particular hardware accelerator”), e.g., independently and in parallel with each other, to generate a corresponding partial output for the fully connected layer. The partial outputs generated across the plurality of hardware accelerators as a result of performing the process 400 can then be combined, e.g., summed, to generate the output for the fully connected layer.

$${a}_{i , j} {x}_{i} ∈ {ℝ}^{\frac{n}{k}} {y}_{i} ∈ {ℝ}^{\frac{m}{k}}$$

The system loads a subset of the plurality of parameter blocks arranged along the row dimension, one after another over multiple hardware cycles, into a particular hardware accelerator (step 402).

$${a}_{i , j} {x}_{i} ∈ {ℝ}^{\frac{n}{k}} {y}_{i} ∈ {ℝ}^{\frac{m}{k}}$$

The system receives, at each of the multiple hardware cycles, and for each parameter block in the subset of the plurality of parameter blocks, a corresponding input vector at the particular hardware accelerator (step 404).

$${a}_{i , j} {x}_{i} ∈ {ℝ}^{\frac{n}{k}} {y}_{i} ∈ {ℝ}^{\frac{m}{k}}$$

The system generates a partial output vector for the fully connected layer by determining a multiplication between (i) each parameter block in the subset of the plurality of parameter blocks and (ii) the corresponding input vector over the multiple hardware cycles while communicating the corresponding input vectors to other hardware accelerators over an accelerator interconnect network during the multiple hardware cycles (step 406).

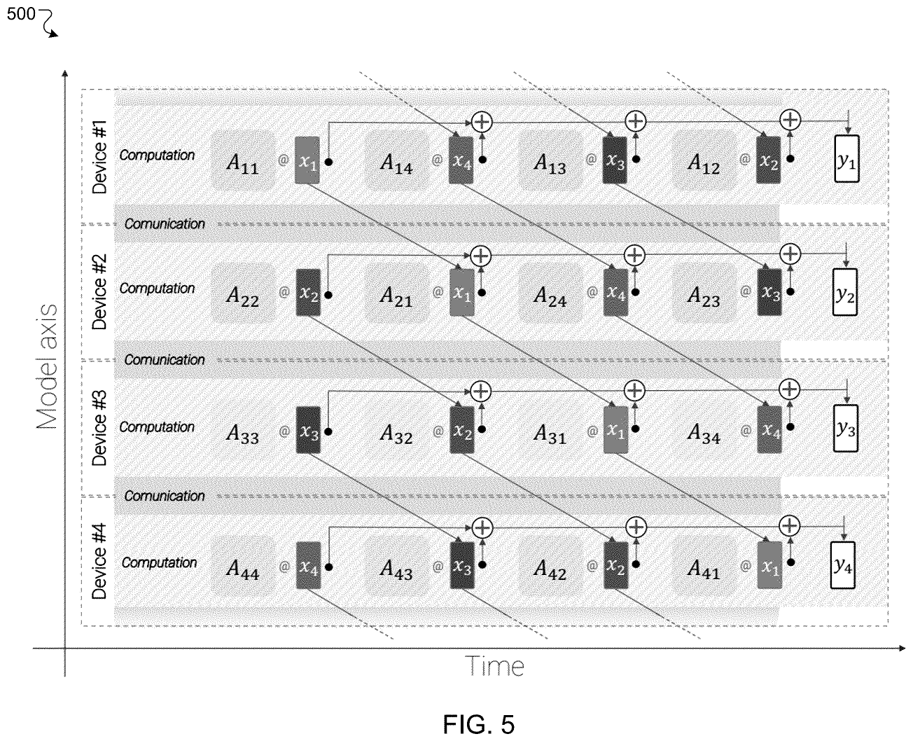

FIG. 5 is an example illustration 500 of using row sharding with the plurality of hardware accelerators. In FIG. 5, the vertical axis is spatial, with each row corresponding to a particular hardware accelerator (“Device #1,” “Device #2,” “Device #3,” and “Device #4”), and the horizontal axis is temporal, with older hardware cycles on the left and the most hardware cycles on the right.

In FIG. 5, the fully connected layer has a parameter matrix A that is in the form of:

$$A = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ]$$

where a₁₁, a₁₂, and so on represent respective parameter blocks. Each parameter block includes a respective subset of the plurality of parameters for the fully connected layer.

FIG. 5 illustrates that a subset of the plurality of parameter blocks arranged along the first row a₁₁, a₁₄, a₁₃, a₁₂ are loaded one after another over multiple hardware cycles into the first hardware accelerator (“Device #1”). Some of these parameter blocks that are loaded in successive hardware cycles can be immediate horizontal neighbors of each other.

At the first hardware cycle, a parameter block a₁₁ is loaded into the first hardware accelerator; an input vector x₁ is received at the first hardware accelerator; and the first hardware accelerator computes a product between the parameter block a₁₁ and the input vector x₁: a₁₁@x₁. In the meanwhile, the first hardware accelerator communicates the input vector x₁ to the second hardware accelerator (“Device #2”), e.g., over an accelerator interconnect network, for its use in the second hardware cycle.

At the second hardware cycle, a parameter block a₁₄ is loaded into the first hardware accelerator; an input vector x₄ is received at the first hardware accelerator; and the first hardware accelerator computes a product between the parameter block a₁₄ and the input vector x₄: a₁₄@x₄. In the meanwhile, the first hardware accelerator communicates the input vector x₄ to the second hardware accelerator (“Device #2”) for its use in the third hardware cycle.

At the third hardware cycle, a parameter block a₁₃ (which is an immediate horizontal neighbor of the parameter block a₁₄) is loaded into the first hardware accelerator; an input vector x₃ is received at the first hardware accelerator; and the first hardware accelerator computes a product between the parameter block a₁₃ and the input vector x₃: a₁₃@x₃. In the meanwhile, the first hardware accelerator communicates the input vector x₃ to the second hardware accelerator (“Device #2”) for its use in the fourth hardware cycle.

At the fourth hardware cycle, parameter block a₁₂ (which is an immediate horizontal neighbor of the parameter block a₁₃) is loaded into the first hardware accelerator; an input vector x₂ is received at the first hardware accelerator; and the first hardware accelerator computes a product between the parameter block a₁₂ and the input vector x₂: a₁₂@x₂.

After four hardware cycles, a partial output y₁ for the fully connected layer can be determined based on the combination of the products that have been computed at the first hardware accelerator over the four hardware cycles: a₁₁@x₁, a₁₄@x₄, a₁₃@x₃, and a₁₂@x₂. It will be appreciated that the hardware accelerators may operate as described above asynchronously.

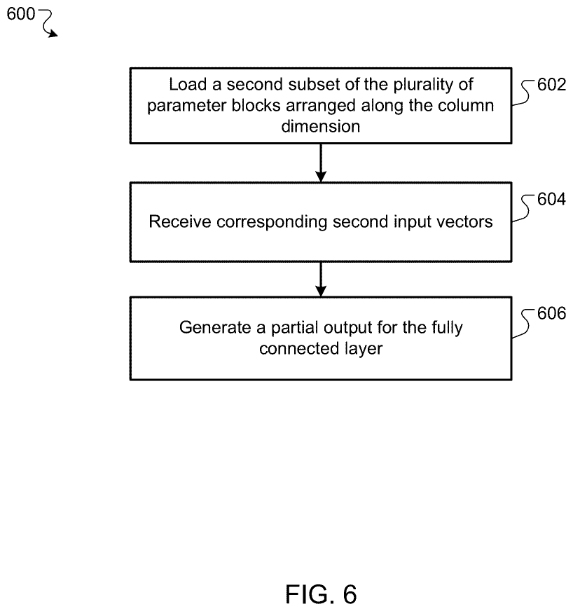

FIG. 6 is a flow diagram of an example process 600 for using column sharding with the plurality of hardware accelerators to calculate the output for the fully connected layer. For convenience, the process 600 will be described as being performed by a system of one or more computers located in one or more locations. For example, a system, e.g., the system 100 of FIG. 1, appropriately programmed, can perform the process 600.

Process 600 can be performed at each of the plurality of hardware accelerators (referred to below as “a particular hardware accelerator”), e.g., independently and in parallel with each other, to generate a corresponding partial output for the fully connected layer. The partial outputs generated across the plurality of hardware accelerators as a result of performing the process 600 can then be combined, e.g., summed, to generate the output for the fully connected layer.

$${a}_{i , j} {x}_{i} ∈ {ℝ}^{\frac{n}{k}} {y}_{i} ∈ {ℝ}^{\frac{m}{k}}$$

The system loads a subset of the plurality of parameter blocks arranged in the column dimension, one after another over multiple hardware cycles, into a particular hardware accelerator (step 602).

$${a}_{i , j} {x}_{i} ∈ {ℝ}^{\frac{n}{k}} {y}_{i} ∈ {ℝ}^{\frac{m}{k}}$$

The system receives, at each of the multiple hardware cycles, and for each parameter block in the subset of the plurality of parameter blocks, a corresponding input vector at the particular hardware accelerator (step 604).

$${a}_{i , j} {x}_{i} ∈ {ℝ}^{\frac{n}{k}} {y}_{i} ∈ {ℝ}^{\frac{m}{k}}$$

The system generates the partial output for the fully connected layer by determining a multiplication between (i) each parameter block in the subset of the plurality of parameter blocks and (ii) the input vector over one or more hardware cycles while communicating corresponding results of the multiplications to the other hardware accelerators over the accelerator interconnect network during the multiple hardware cycles (step 606).

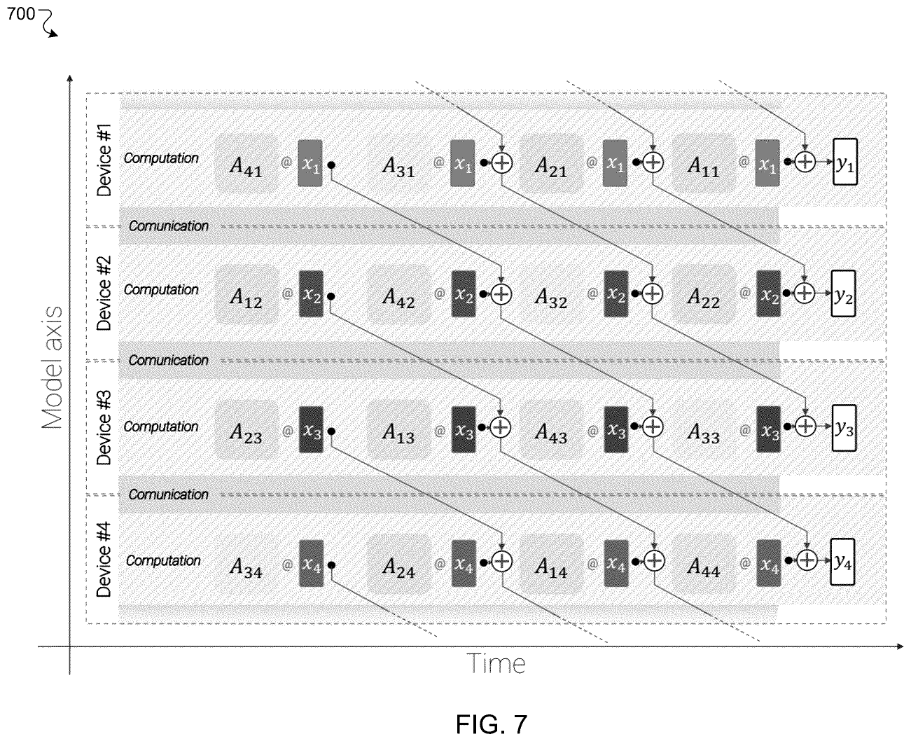

FIG. 7 is an example illustration 700 of using row sharding with the plurality of hardware accelerators. In FIG. 7, the vertical axis is spatial, with each row corresponding to a particular hardware accelerator (“Device #1,” “Device #2,” “Device #3,” and “Device #4”), and the horizontal axis is temporal, with older hardware cycles on the left and the most hardware cycles on the right.

In FIG. 7, the fully connected layer has a parameter matrix A that is in the form of:

$$A = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ]$$

where a₁₁, a₁₂, and so on represent respective parameter blocks. Each parameter block includes a respective subset of the plurality of parameters for the fully connected layer.

FIG. 7 illustrates that a subset of the plurality of parameter blocks arranged along the first column a₄₁, a₃₁, a₂₁, a₁₁ are loaded one after another over multiple hardware cycles into the first hardware accelerator (“Device #1”). Some of these parameter blocks that are loaded in successive hardware cycles can be immediate vertical neighbors of each other.

At the first hardware cycle, a parameter block a₄₁ is loaded into the first hardware accelerator; an input vector x₁ is received at the first hardware accelerator; and the first hardware accelerator computes a product between the parameter block a₄₁ and the input vector x₁: a₄₁@x₁. The first hardware accelerator communicates the product a₄₁@x₁ to the second hardware accelerator (“Device #2”), e.g., over an accelerator interconnect network.

At the second hardware cycle, a parameter block a₃₁ (which is an immediate vertical neighbor of the parameter block a₄₁) is loaded into the first hardware accelerator; an input vector x₁ is received at the first hardware accelerator; and the first hardware accelerator computes a product between the parameter block a₃₁ and the input vector x₁: a₃₁@x₁. The first hardware accelerator communicates the product a₃₁@x₁ to the second hardware accelerator (“Device #2”).

At the third hardware cycle, a parameter block a₂₁ (which is an immediate vertical neighbor of the parameter block a₃₁) is loaded into the first hardware accelerator; an input vector x₁ is received at the first hardware accelerator; and the first hardware accelerator computes a product between the parameter block a₂₁ and the input vector x₁: a₂₁@x₁. The first hardware accelerator communicates the product a₂₁@x₁ to the second hardware accelerator (“Device #2”).

At the fourth hardware cycle, parameter block a₁₁ (which is an immediate horizontal neighbor of the parameter block a₂₁) is loaded into the first hardware accelerator; an input vector x₁ is received at the first hardware accelerator; and the first hardware accelerator computes a product between the parameter block a₁₁ and the input vector x₁: a₁₁@x₁.

After four hardware cycles, a partial output y₁ for the fully connected layer can be determined based on the combination of (i) the product that has been computed at the first hardware accelerator in the fourth hardware cycle a₁₁@x₁ and (ii) the product that has been computed at another hardware accelerator in the third hardware cycle.

It will be appreciated that the hardware accelerators may operate as described above asynchronously.

Turning back to FIG. 3, generally, by performing the computation for each fully connected layer in this manner and each other layer included in the neural network in analogous manners in accordance with the plurality of parameters for the layer, the system can generate an output at the final layer of the neural network.

Optionally, the system determines a loss of the output relative to a ground truth output of the input, and determines an update to the values of the plurality of parameters for the fully connected layer based on the loss (step 310). For example, the loss can be determined by evaluating any appropriate loss function that measures a difference between the output and the ground truth output of the input, and the update can be determined by computing a backpropagation of the loss through the plurality of parameters. Like in the forward pass, the system can choose between using either row sharding or column sharding with the plurality of hardware accelerators in the backward pass based on the dimensions of the parameter matrix.

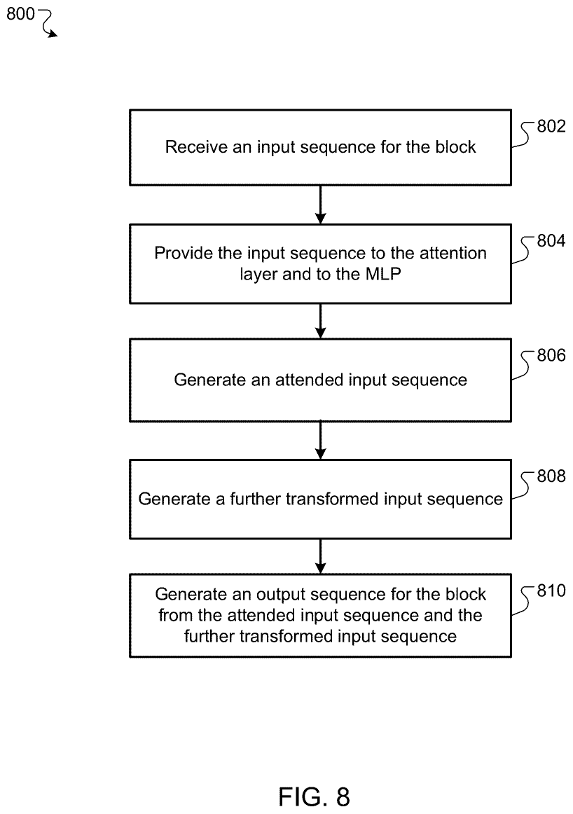

FIG. 8 is a flow diagram of an example process 800 for performing a machine learning task on a network input to generate a network output. For example, the network input includes a plurality of image patches of an image, where each image patch comprises a different subset of the pixels of the image, and the network output is a classification output for the image. For convenience, the process 800 will be described as being performed by a system of one or more computers located in one or more locations. For example, a system, e.g., the system 100 of FIG. 1 or another system that includes the ViT neural network 200 of FIG. 2, appropriately programmed in accordance with this specification, can perform the process 800.

The ViT neural network includes an attention subnetwork. The attention subnetwork includes a plurality of parallel attention blocks. Each parallel attention block includes an attention layer, a multi-layer perceptron (MLP), and, in some implementations, an attention output projection layer. The MLP, in turn, includes an input multi-layer perceptron (MLP) and an output multi-layer perceptron (MLP) that are separated by an activation layer. The system can perform process 800 for each of the plurality of parallel attention blocks.

The system receives an input sequence for the parallel attention block (step 802). The input sequence includes a respective input element at each of a plurality of positions. For the first parallel attention block, the input sequence can be the corresponding embedding of each of the plurality of image patches of the image that are generated by the image patch embedding layer. For any subsequent parallel attention block, the input sequence can be the output sequence generated by the preceding parallel attention block.

The system provides the input sequence to both the attention layer and the input MLP included in the parallel attention block (step 804).

The system generates, using the attention layer, an attended input sequence that includes a respective attended input element for each of the plurality of positions at least in part by applying an attention mechanism to the input sequence for the block (step 806).

In some implementations, the system processes the attended input sequence using the attention output projection layer to generate a projected attended input sequence. The projected attended input sequence can then be used as the attended input sequence. In some of these implementations, generating the projected attended input sequence includes applying an attention output projection matrix to the input sequence, and adding an attention output projection bias vector.

In some implementations, applying the attention mechanism includes applying a query parameter matrix, a key parameter matrix, and a value parameter matrix to the input sequence for the layer to generate the set of queries Q, the set of keys K, and the set of values V. However, applying the attention mechanism does not include adding any bias vector.

In some implementations, applying the query parameter matrix to generate the set of queries Q also includes applying a layer normalization. In some implementations, applying the key parameter matrix also includes applying a layer normalization. In some implementations, applying the value parameter matrix does not include applying any layer normalization.

The system generates, using the MLP, and from the input sequence for the block, a further transformed input sequence that includes a respective further transformed input element for each of the plurality of positions (step 808).

More specifically, the system processes the input sequence by using one or more feed-forward neural network layers included in the input MLP to generate a transformed input sequence that includes a respective transformed input element for each of the plurality of positions.

In some implementations, generating the transformed input sequence includes applying a feed-forward input projection parameter matrix to the input sequence for the layer to generate a projected input sequence, and adding an input projection bias vector to the projected input sequence.

The system processes the transformed input sequence using the activation layer to generate an activated transformed input sequence. For example, the activation layer can be a Gaussian Error Linear Unit (GELU) activation layer that applies a GELU activation function to the transformed input sequence.

The system then processes the activated transformed input sequence by using one or more feed-forward neural network layers included in the output MLP to generate the further transformed input sequence that includes the respective further transformed input element for each of the plurality of positions.

In some implementations, generating the further transformed input sequence includes applying a feed-forward output projection parameter matrix to the activated transformed input sequence to generate a projected activated transformed input sequence, and adding an output projection bias vector to the projected activated transformed input sequence.

The system generates, at the parallel attention block, the output sequence for the parallel attention block by determining a combination of the attended input sequence and the further transformed input sequence (step 810). In some implementations, the output sequence has the same length as the input sequence, i.e., include a respective output element at each of the plurality of positions.

The system can generate this combination in any appropriate way. In some implementations, the system can determine the combination of the attended input sequence and the further transformed input sequence by, for each of the plurality of positions, computing a sum of the respective attended input element and the respective further transformed input element for the position.

In some other implementations, the system can determine the combination by computing a weighted or unweighted average between the respective attended input elements and the respective further transformed input elements at the plurality of positions, or by concatenating the attended input sequence to the further transformed input sequence and then processing the concatenating using a pooling layer to reduce its length.

By repeatedly performing the process 800 for all of the plurality of parallel attention blocks in the ViT neural network and then by processing at least part of the output sequence generated by the last parallel attention block in the ViT neural network using one or more output layers, the system can generate the network output for the network input.

That is, the process 800 can be performed as part of generating a predicted classification output for an image for which the desired classification output, i.e., the ground truth classification of the image that should be generated by the system for the image, is not known.

The process 800 can also be performed as part of processing inputs derived from a set of training data, i.e., inputs derived from a set of inputs for which the output that should be generated by the system is known, in order to train the ViT neural network to determine trained values for the parameters of the ViT neural network.

The system can repeatedly perform the process 800 on inputs selected from a set of training data as part of a conventional machine learning training technique to train the parallel attention blocks and other components of the ViT neural network, e.g., a gradient descent with backpropagation training technique that uses a conventional optimizer, e.g., stochastic gradient descent, RMSprop, or Adam optimizer, to optimize an objective function that is appropriate for the task that the ViT neural network is configured to perform.

In one example, the set of training data can be the JFT-300M dataset (described in Chen Sun, et al. Revisiting unreasonable effectiveness of data in deep learning era. In CVPR, pages 843-852, 2017). In one example, when the task is a multi-label classification, the objective function can be a sigmoid cross-entropy loss.

In some cases, the system can first pre-train the ViT neural network on a large unsupervised data set through unsupervised learning, and then adapt the pre-train ViT neural network to one of the machine learning tasks mentioned above by fine-tuning the ViT neural network on task-specific training data to optimize the objective function for the task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for processing an input through each of a plurality of layers of a neural network to generate an output using a plurality of hardware accelerators, wherein the plurality of layers comprise a fully connected layer having a plurality of parameters arranged in a row dimension and a column dimension, and wherein the method comprises:
generating a plurality of parameter blocks by partitioning the plurality of parameters along the row dimension and the column dimension according to a number of the plurality of hardware accelerators;
determining a ratio of a number of parameters along the row dimension relative to a number of parameters along the column dimension; and
determining, from the ratio, whether to use row sharding or column sharding with the plurality of hardware accelerators to calculate an output for the fully connected layer and then calculating the output for the fully connected layer using either row sharding or column sharding.

2. The method of claim 1, wherein using row sharding comprises:
loading a first subset of the plurality of parameter blocks arranged along the row dimension one after another into a particular hardware accelerator;
receiving, for each parameter block in the first subset of the plurality of parameter blocks, a corresponding first input vector at the particular hardware accelerator; and
generating a partial output for the fully connected layer by determining a multiplication between (i) each parameter block in the first subset of the plurality of parameter blocks and (ii) the corresponding first input vector over one or more hardware cycles while communicating the corresponding first input vectors to other hardware accelerators over an accelerator interconnect network during the one or more hardware cycles.

3. The method of claim 2, wherein loading the first subset of the plurality of parameter blocks arranged along the row dimension one after another into the particular hardware accelerator comprises:
loading a first parameter block in the first subset of the plurality of parameter blocks into the particular hardware accelerator; and
loading a second parameter block in the first subset of the plurality of parameter blocks into the particular hardware accelerator, wherein the second parameter block is an immediate horizontal neighbor of the first parameter block.

4. The method of claim 1, wherein using column sharding comprises:
loading a second subset of the plurality of parameter blocks arranged in the column dimension one after another into the particular hardware accelerator;
receiving a second input vector at the particular hardware accelerator; and
generating the partial output for the fully connected layer by determining a multiplication between (i) each parameter block in the second subset of the plurality of parameter blocks and (ii) the second input vector over one or more hardware cycles while communicating corresponding results of the multiplications to the other hardware accelerators over the accelerator interconnect network during the multiple hardware cycles.

5. The method of claim 4, wherein loading the second subset of the plurality of parameter blocks arranged in the column dimension one after another into the particular hardware accelerator comprises:
loading a first parameter block in the second subset of the plurality of parameter blocks into the particular hardware accelerator; and
loading a second parameter block in the second subset of the plurality of parameter blocks into the particular hardware accelerator, wherein the second parameter block is an immediate vertical neighbor of the first parameter block.

6. The method of claim 1, wherein calculating the output for the fully connected layer comprises computing a summation of the partial outputs for the fully connected layer.

7. The method of claim 1, further comprising:
determining a loss of the output relative to a ground truth output of the input; and
determining an update to the plurality of parameters of the fully connected layer based on the loss.

8. The method of claim 7, wherein determining the update to the plurality of parameters comprises computing a backpropagation of the loss through the plurality of parameters using either row sharding or column sharding.

9. A system comprising one or more computers and one or more storage devices storing instructions that when executed by the one or more computers cause the one more computers to perform operations for processing an input through each of a plurality of layers of a neural network to generate an output using a plurality of hardware accelerators, wherein the plurality of layers comprise a fully connected layer having a plurality of parameters arranged in a row dimension and a column dimension, and wherein the operations comprise:
generating a plurality of parameter blocks by partitioning the plurality of parameters along the row dimension and the column dimension according to a number of the plurality of hardware accelerators;
determining a ratio of a number of parameters along the row dimension relative to a number of parameters along the column dimension; and
determining, from the ratio, whether to use row sharding or column sharding with the plurality of hardware accelerators to calculate an output for the fully connected layer and then calculating the output for the fully connected layer using either row sharding or column sharding.

10. The system of claim 9, wherein using row sharding comprises:
loading a first subset of the plurality of parameter blocks arranged along the row dimension one after another into a particular hardware accelerator;
receiving, for each parameter block in the first subset of the plurality of parameter blocks, a corresponding first input vector at the particular hardware accelerator; and
generating a partial output for the fully connected layer by determining a multiplication between (i) each parameter block in the first subset of the plurality of parameter blocks and (ii) the corresponding first input vector over one or more hardware cycles while communicating the corresponding first input vectors to other hardware accelerators over an accelerator interconnect network during the one or more hardware cycles.

11. The system of claim 10, wherein loading the first subset of the plurality of parameter blocks arranged along the row dimension one after another into the particular hardware accelerator comprises:
loading a first parameter block in the first subset of the plurality of parameter blocks into the particular hardware accelerator; and
loading a second parameter block in the first subset of the plurality of parameter blocks into the particular hardware accelerator, wherein the second parameter block is an immediate horizontal neighbor of the first parameter block.

12. The system of claim 9, wherein using column sharding comprises:
loading a second subset of the plurality of parameter blocks arranged in the column dimension one after another into the particular hardware accelerator;
receiving a second input vector at the particular hardware accelerator; and
generating the partial output for the fully connected layer by determining a multiplication between (i) each parameter block in the second subset of the plurality of parameter blocks and (ii) the second input vector over one or more hardware cycles while communicating corresponding results of the multiplications to the other hardware accelerators over the accelerator interconnect network during the multiple hardware cycles.

13. The system of claim 12, wherein loading the second subset of the plurality of parameter blocks arranged in the column dimension one after another into the particular hardware accelerator comprises:
loading a first parameter block in the second subset of the plurality of parameter blocks into the particular hardware accelerator; and
loading a second parameter block in the second subset of the plurality of parameter blocks into the particular hardware accelerator, wherein the second parameter block is an immediate vertical neighbor of the first parameter block.

14. One or more computer storage media storing instructions that when executed by one or more computers cause the one more computers to perform operations for processing an input through each of a plurality of layers of a neural network to generate an output using a plurality of hardware accelerators, wherein the plurality of layers comprise a fully connected layer having a plurality of parameters arranged in a row dimension and a column dimension, and wherein the operations comprise:
generating a plurality of parameter blocks by partitioning the plurality of parameters along the row dimension and the column dimension according to a number of the plurality of hardware accelerators;
determining a ratio of a number of parameters along the row dimension relative to a number of parameters along the column dimension; and
determining, from the ratio, whether to use row sharding or column sharding with the plurality of hardware accelerators to calculate an output for the fully connected layer and then calculating the output for the fully connected layer using either row sharding or column sharding 8.

15. A system for performing a machine learning task on a network input to generate a network output, the system comprising one or more computers and one or more storage devices storing instructions that, when executed by the one or more computers, cause the one or more computers to implement:
a vision Transformer neural network configured to perform the machine learning task, the attention neural network comprising a plurality of attention blocks, each attention block comprising an attention layer and an input multi-layer perceptron (MLP), the attention block configured to:
receive an input sequence for the block comprising a respective input element at each of a plurality of positions;
provide the input sequence to the attention layer and to the input MLP,
the attention layer configured to generate an attended input sequence that includes a respective attended input element for each of the plurality of positions at least in part by applying an attention mechanism to the input sequence for the block, wherein applying the attention mechanism (i) requires applying a query parameter matrix, a key parameter matrix, and a value parameter matrix to the input sequence for the layer but (ii) does not require adding any bias vector, and
the input MLP configured to generate a transformed input sequence that includes a respective transformed input element for each of the plurality of positions by using one or more feed-forward neural network layers included in the input MLP to process the input sequence for the block, wherein generating the transformed input sequence requires both (i) applying a feed-forward input projection parameter matrix to the input sequence for the layer to generate a projected input sequence and (ii) adding an input projection bias vector to the projected input sequence; and
generate the output sequence for the block from the attended input sequence and the transformed input sequence.

16. The system of claim 15, wherein each attention block comprises one or more attention output projection layers and an output multi-layer perceptron (MLP), and wherein the attention block is configured to:
process the attended input sequence using the an attention output projection layer to generate a projected attended input sequence;
process the transformed input sequence using the output MLP to generate a further transformed input sequence; and
generating the output sequence for the block by determining a combination of the projected attended input sequence and the further transformed input sequence.

17. The system of claim 16, wherein:
generating the projected attended input sequence includes (i) applying an attention output projection matrix to the input sequence and (ii) adding an attention output projection bias vector; and
generating the further transformed input sequence includes both (i) applying a feed-forward output projection parameter matrix to the transformed input sequence to generate a projected transformed input sequence and (ii) adding an output projection bias vector to the projected transformed input sequence.

18. The system of claim 15, wherein:
applying the query parameter matrix comprises applying a layer normalization;
applying the key parameter matrix comprises applying the layer normalization; and
applying the value parameter matrix does not comprise applying any layer normalization.

19. The system of claim 15, wherein each attention block is configured to apply a Gaussian Error Linear Unit (GELU) activation function to the transformed input sequence.

20. The system of claim 15, wherein:
the machine learning task comprises an image classification task;
the network input comprises a plurality of image patches of an image, wherein each image patch comprises a different subset of the pixels of the image; and
the network output comprises a classification output for the image.
